(19) United States
(12) Patent Application Publication
(10) Pub. No.: US 2013/0146604 A1
(43) Pub. Date: Jun. 13, 2013

(54) FUEL LEVEL SENSOR AND FUEL TANK ASSEMBLY

(71) Applicants: DANIEL J. MORENO, EL PASO, TX (US); YINGJIE LIN, EL PASO, TX (US)

(72) Inventors: DANIEL J. MORENO, EL PASO, TX (US); YINGJIE LIN, EL PASO, TX (US)

(73) Assignee: DELPHI TECHNOLOGIES, INC., TROY, MI (US)

(21) Appl. No.: 13/324,243

(22) Filed: Dec. 13, 2011

(51) Int. Cl. B65D 88/12; G01F 23/38

(52) U.S. Cl. 220/562; 73/317

(57) ABSTRACT

A fuel level sensor assembly includes a magnetic sensor for sensing a magnetic field corresponding to fuel level. The magnetic sensor includes a magnetic sensing element packaged within a hermetically sealed non-magnetic metal case. The magnetic sensing element may be a Hall effect, giant magnetoresistive (GMR), or anisotropic magnetoresistive (AMR) sensor. The case may correspond to the dimensions of a standard transistor outline (TO) package such as TO-3, TO-5, TO-8, TO-18, TO-39, TO-46, TO-52, or TO-72.

### TECHNICAL FIELD OF INVENTION

The invention generally relates to fuel level sensor for a motor vehicle, and more particularly relates to a fuel level sensor that uses a magnetic sensor to determine fuel level.

### BACKGROUND OF INVENTION

Fuel level sensors in vehicle fuel tanks that indicate fuel level by way of a change in resistance proportional to the angular position of the float arm of the fuel level sensor are known. The resistance-based fuel level sensor uses a mechanical contact between a wiper assembly on a rotor and a printed resistor on a ceramic substrate on a stator. Resistive sensors present reliability issues due to wear and degradation of the contact resistance from exposure to aggressive fuels. The increased diversity in fuels has led to improvements in the sensor design and materials but it has also to significant increases in cost due to use of precious metals to improve the resistive sensor's robustness.

There are several alternatives to the unsealed resistive fuel level sensor that use magnetic, ultrasonic, capacitive, or other types of sensors. There are several types of magnetic field sensors including, but not limited to, Hall effect sensors, giant magnetoresistive (GMR) sensors, and anisotropic magnetoresistive (AMR) sensors. These magnetic field sensors are typically integrated on a silicon substrate. These magnetic field sensors are susceptible to durability issues when exposed to corrosive fuels. Magnetic field sensors are typically assembled in standard plastic electronic packages in which a silicon substrate and a metal lead frame are encapsulated in a plastic over-mold. There is typically little adhesion between the lead frame and the plastic over-mold, allowing fuel to infiltrate the package. Therefore, the magnetic field sensor is typically encapsulated by a secondary coating and/or potting material to protect it from the fuel. This secondary coating or potting material should be compatible with a wide range of fuel compositions that are commonly in use. The wide range of fuels may require combinations of coatings and encapsulants to ensure protection of the element. Therefore, a fuel level sensor assembly is desired that protects the magnetic field sensor from the fuel tank environment without the need for secondary coating or potting material.

### SUMMARY OF THE INVENTION

In accordance with one embodiment of this invention, a fuel level sensor assembly configured to be installed in a vehicle fuel tank is provided. The assembly includes a case that defines a cavity and an opening, wherein the case is formed of non-magnetic metal. The assembly further includes a cap defining a via or hole through the cap. The cap fixedly attached to the opening. The assembly also includes a magnetic field sensor that may be, but is not limited to, a Hall effect sensor, giant magnetoresistive (GMR) sensor, or anisotropic magnetoresistive (AMR) sensor, hereafter referred to as a magnetic sensing element, located within the cavity. The magnetic sensing element defines a contact area for making electrical contact with the magnetic sensing element. The assembly additionally includes a pin protruding through the via and a wire bonded to the contact area and the pin. The wire electrically connects the magnetic sensing element to the pin. The assembly further includes a sealant located within the via between the pin and the cap, whereby the sealant defines a hermetic seal between the pin and the cap. The case, the cap, the magnetic sensing element, the pin, the wire, and the sealant are assembled to form a magnetic sensor.

In another embodiment of the present invention, a fuel level sensor assembly configured to be installed in a vehicle fuel tank is provided. In addition to the magnetic sensor, the assembly includes a base defining a surface for mounting the magnetic sensor. Additionally, the assembly includes a float arm having a first end rotatably supported by the base for rotation about an axis offset from the magnetic sensor by a first distance. The assembly further includes a magnet attached to the first end and positioned to rotate about a first axis and offset by a second distance. The assembly also includes a float attached to a second end of the float arm, whereby movement of the float about the first axis causes rotation of the first end. The assembly also includes an interface circuit electrically connected to the pin, wherein the interface circuit is configured to condition a voltage supply of the magnetic sensing element and converts a magnetic sensing element output to interface with a vehicle controller.

In yet another embodiment of the present invention, a fuel tank assembly is configured to be installed in a vehicle is provided. The assembly includes a fuel tank and fuel level sensor assembly. The fuel level sensor assembly includes a magnetic sensor.

The magnetic sensor includes a case that defines a cavity and an opening. The case is formed of non-magnetic metal. The magnetic sensor includes a cap defining a via. The cap is fixedly attached to the opening. The magnetic sensor further includes a magnetic sensing element located within the cavity. The magnetic sensing element defines a contact area for making electrical contact with the magnetic sensing element. The magnetic sensor also contains a pin protruding through the via and a wire that is bonded to the contact area and the pin. The wire electrically connects the magnetic sensing element to the pin. The magnetic sensor also includes a sealant located within the via between the pin and the cap, whereby the sealant defines a hermetic seal between the pin and the cap.

The fuel level sensor assembly also includes a base defining a surface for mounting the magnetic sensor. The fuel level sensor assembly further includes a float arm having a first end rotatably supported by the base for rotation about an axis offset from the magnetic sensor by a first distance. The fuel level sensor assembly also contains a magnet attached to the first end and positioned to rotate about a first axis and offset by a second distance. Additionally, the fuel level sensor assembly includes a float attached to a second end of the float arm, whereby movement of the float about the first axis causes rotation of the first end. The fuel level sensor assembly further includes an interface circuit electrically connected to the pin, wherein the interface circuit is configured to condition a voltage supply of the magnetic sensing element and converts an electrical output of the magnetic sensing element to interface with a vehicle controller.

Further features and advantages of the invention will appear more clearly on a reading of the following detailed description of the preferred embodiment of the invention, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a cut-away view of a fuel tank assembly including a fuel level sensor assembly in accordance with one embodiment;

FIG. 2 is a sectional of a magnetic sensor configured for use in a fuel tank assembly of FIGS. 1 and 3; and

FIG. 3 is cut-away view of a fuel tank assembly including a fuel level sensor assembly in accordance with another embodiment.

### DETAILED DESCRIPTION OF INVENTION

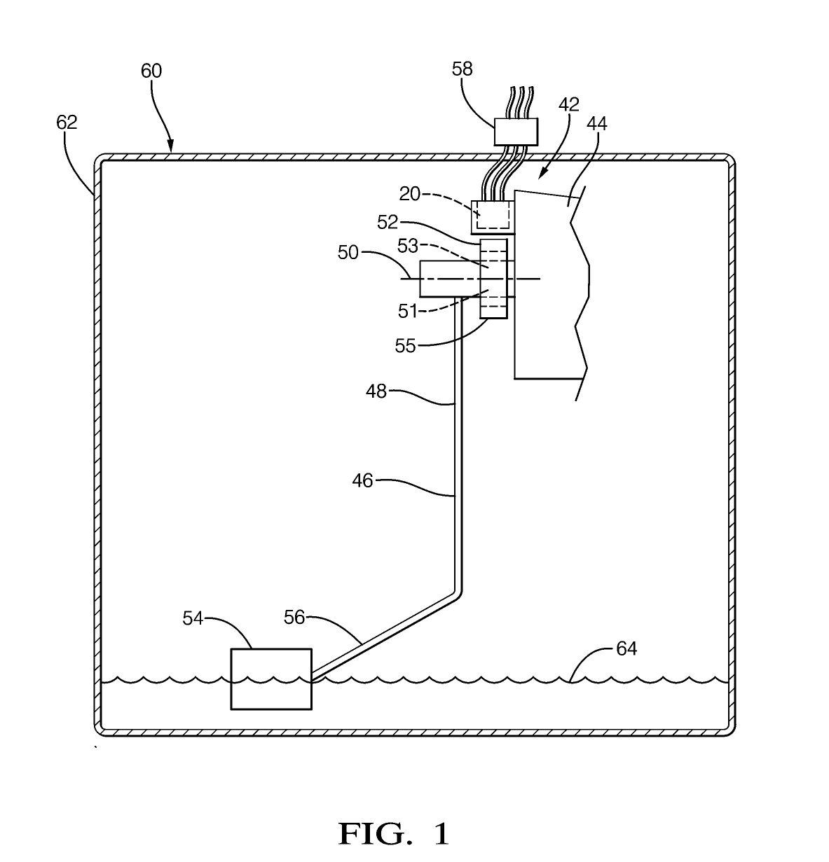

FIG. 1 illustrates a non-limiting example of a fuel level sensor assembly 42 configured to be installed in a vehicle fuel tank 62 that uses a magnetic sensing element 32 to detect a magnetic field produced by a movable magnet 52 attached to a float arm 46 to detect a fuel level 64 in the vehicle fuel tank 62. The magnetic sensing element 32 may include signal processing circuitry, electromagnetic interference protection circuitry, and/or filtering circuitry. The fuel level sensor assembly 42 preferably uses hermetic packaging to isolate the magnetic sensing element 32 from the fuel exposure in the fuel tank. Since the magnetic sensing element 32 may be hermetically sealed within a magnetic sensor 20, secondary coatings or potting materials are usually not required to protect the magnetic sensing element 32 from fuel exposure. As a non-limiting example, the magnetic sensing element 32 may include a Hall effect sensor, giant magnetoresistive (GMR) sensor, or anisotropic magnetoresistive (AMR) sensor.

The magnetic sensing element 32 is typically available with either a two terminal configuration or a three terminal configuration. This enables the magnetic sensing element 32 to be packaged within a standard Transistor Outline (TO) package that may consist of a metal housing with welded interfaces and glass seals between the terminals and the housing to form the magnetic sensor 20. TO package dimensions are defined by the Joint Electron Devices Engineering Council (JEDEC) JC-11 Committee on Mechanical Standardization in JEDEC Publication JEP-95.

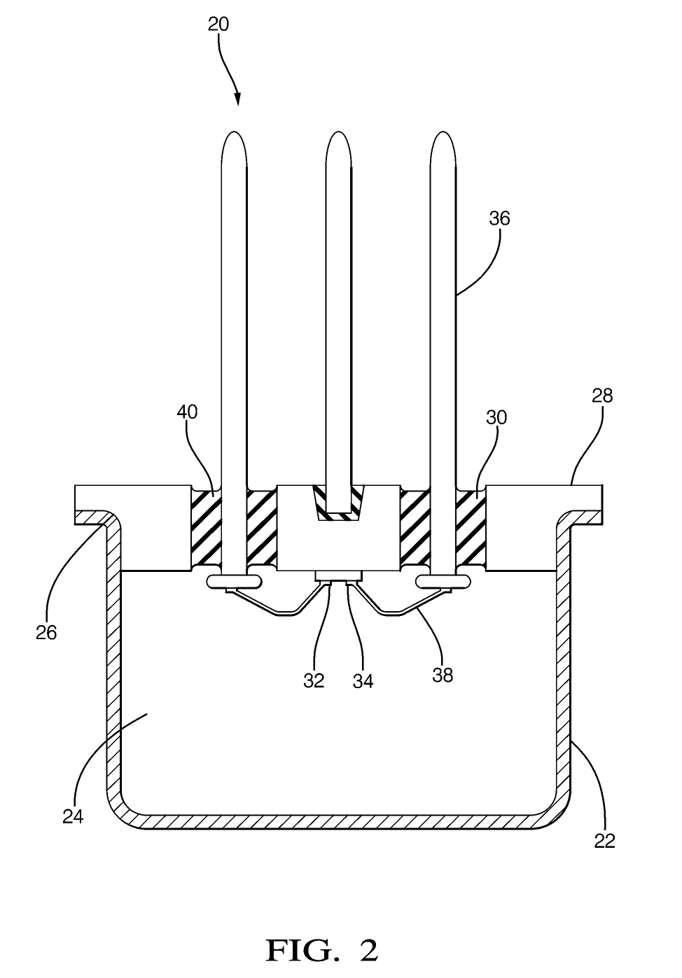

As shown in FIG. 2, the magnetic sensor 20 includes a case 22 that defines a cavity 24 and an opening 26. By way of example and not limitation, the case 22 may be formed of non-magnetic metal, such as aluminum or austenitic stainless steel. Alternatively, the case 22 may be formed of ceramic, glass, or other material capable of providing hermetic protection for the magnetic sensor 20 and allowing magnetic fields to pass through the case 22 substantially unimpeded. The magnetic sensor 20 further includes a cap 28 defining a via 30. The cap 28 may be formed of non-magnetic metal, such as aluminum or austenitic stainless steel or alternately ceramic, glass, or other material capable of providing hermetic protection for the magnetic sensor 20. The cap 28 is fixedly attached to the opening 26 of the case 22. In a non-limiting example, the case 22 and the cap 28 may be attached by a welding process to form a hermetic seal.

Continuing to refer to FIG. 2, the magnetic sensor 20 also includes a magnetic sensing element 32 located within the cavity 24 of the case 22. The magnetic sensing element 32 defines a contact area 34 for making electrical contact with the magnetic sensing element 32. The surface of the contact area 34 may be gold, aluminum, or other material suitable for making electrical connection to the magnetic sensing element 32. The magnetic sensor 20 further includes an electrically conductive pin 36 protruding through the via 30 and an electrically conductive wire 38 bonded to the contact area 34 of the magnetic sensing element 32 and the pin 36. The wire 38 electrically connects the magnetic sensing element 32 to the pin 36. The wire 38 may be gold, copper, aluminum, or other material suitable for making electrical connection between the contact area 34 and the pin 36. The wire 38 may be bonded to the contact area 34 and the pin 36 using an ultrasonic, thermosonic, or other process known to a person skilled in the art that is suitable for bonding the wire 38. The pin 36 may provide a communication conduit for the output of the magnetic sensing element 32 to a gauge, vehicle controller, or other device capable of displaying the fuel level 64. The pin 36 may also provide electrical power or ground connections to the magnetic sensing element 32.

The magnetic sensor 20 also includes a sealant 40 located within the via 30 between the pin 36 and the cap 28. The sealant 40 helps to form a hermetic seal between the pin 36 and the cap 28. The sealant 40 may be a glass, epoxy-based, or other material capable of providing a hermetic seal between the pin 36 and the cap 28 and resist attack from corrosive fuels. The sealant 40 is preferably electrically non-conductive.

The case 22, the cap 28, the magnetic sensing element 32, the pin 36, the wire 38, and the sealant 40 are assembled to form the magnetic sensor 20.

Referring again to FIG. 1, FIG. 1 illustrates a fuel level sensor assembly 42 configured to be installed in a vehicle fuel tank 62. In addition to the magnetic sensor 20, the fuel level sensor assembly 42 may further include a base 44 defining a surface for mounting the magnetic sensor 20. The base 44 may be constructed of a polymer or other non-magnetic material capable of withstanding exposure to fuel.

The fuel level sensor assembly 42 may further include a float arm 46 having a first end 48 rotatably supported by the base 44 for rotation about a first axis 50 offset from the magnetic sensor 20 by a first distance 51. The float arm 46 may be constructed of a material capable of withstand exposure to fuel and provide sufficient rigidity. The float arm 46 is preferably constructed of a non-magnetic material.

The fuel level sensor assembly 42 may further include a magnet 52 that may be coupled to the first end 48 and positioned to rotate about a first axis 50. The magnet 52 may be offset from the first axis 50 by a second distance 53. The magnetic sensor 20 may preferably also be offset from the first axis 50 by the second distance 53 in order to maximize the strength of a magnetic field produced by the magnet 52 to which the magnetic sensor 20 is exposed. The fuel level sensor assembly 42 may further include a float 54 connected to a second end 56 of the float arm 46. The float 54 is constructed of a material that is buoyant in fuel. Movement of the float 54 about the first axis 50 may cause rotation of the first end 48.

When the fuel level 64 of the vehicle fuel tank 62 changes, the float 54 changes position, thus moving the float arm 46 and in turn rotating or moving the magnet 52 about the first axis 50. As the magnet 52 rotates around the first axis 50, the magnetic field about the magnetic sensor 20 changes, altering the signal output from the magnetic sensor 20, which corresponds with the amount of fuel located within the vehicle fuel tank 62.

The magnet 52 may be attached to the float arm 46 via a rotor 55. The rotor 55 is rigidly attached to the first end 48 of the float arm 46 so that the rotor 55 rotates in response to a movement of the float arm 46. The rotor 55 may be preferably constructed of a polymer or non-magnetic material so that it does not affect a magnetic circuit created by the magnet 52. The first distance 51 and the second distance 53 may be selected so that a magnetic material in the float arm 46 does not influence the magnetic circuit. The fuel level sensor assembly 42 may include a second magnet 52 configured so that opposite poles of the magnets face each other to produce a strong and uniform magnetic field. The fuel level sensor assembly 42 may also include a magnetic flux concentrator to produce the strong and uniform magnetic field. The strength and uniformity of the magnetic field needed will depend upon the sensitivity of the magnetic sensor 20. The fuel level sensor assembly 42 may also include a ferrous shield to limit disturbance of the magnetic field from external magnetic fields.

The fuel level sensor assembly 42 may further include an interface circuit 58 electrically connected to the pin 36. The interface circuit 58 may condition a voltage supply of the magnetic sensing element 32 and may convert an electrical output of the magnetic sensing element 32 to interface with a gauge, vehicle controller, or other device (not shown) capable of displaying the fuel level 64.

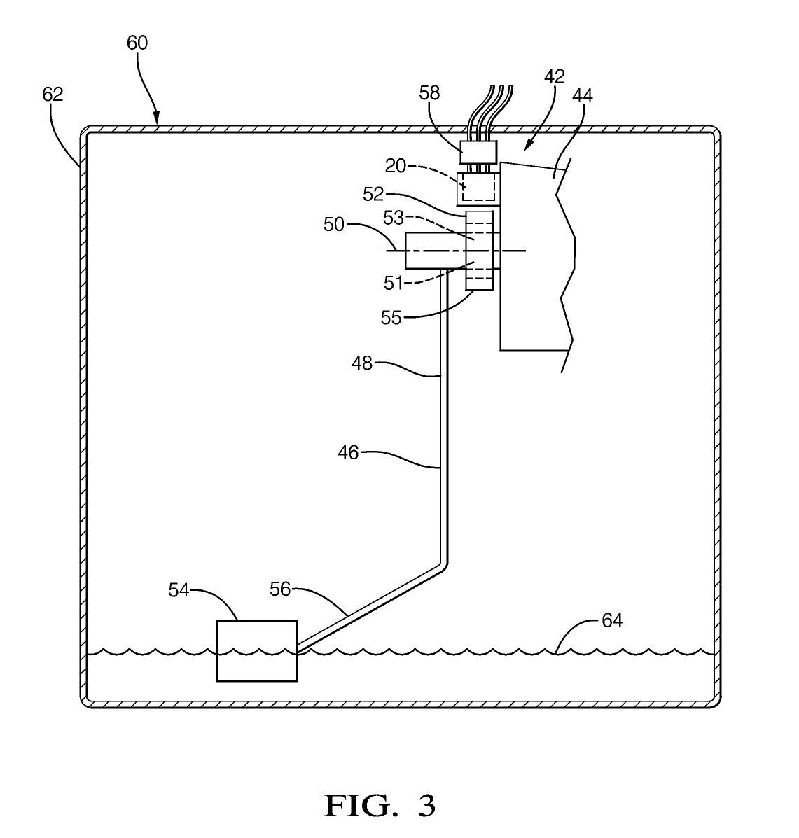

As shown in FIG. 1, the interface circuit 58 may be configured to be located outside of the vehicle fuel tank 62. Alternately, as shown in FIG. 3, the interface circuit 58 may be configured to be located within the vehicle fuel tank 62. According to the embodiment shown in FIG. 3, the interface circuit 58 may be located on a separate circuit board that is configured to withstand exposure to fuel within the fuel tank. The interface circuit 58 may be disposed within the case 22 of the magnetic sensor 20 on either a separate circuit board or as an application specific integrated circuit (ASIC) that includes the magnetic sensing element 32.

The dimensions of the magnetic sensor 20 may be defined corresponding to one of a transistor outline (TO) package dimension selected from a group consisting of TO-3, TO-5, TO-8, TO-18, TO-39, TO-46, TO-52, and TO-72. An embodiment of the magnetic sensor 20 may advantageously correspond to TO-18 package dimensions.

FIG. 1 also illustrates a fuel tank assembly 60 including a vehicle fuel tank 62 and the fuel level sensor assembly 42. The interface circuit 58 may be configured to be located outside of the vehicle fuel tank 62 as shown in FIG. 1. Alternately, the interface circuit 58 may be configured to be located within the vehicle fuel tank 62 as shown in FIG. 3. The interface circuit 58 may be disposed within the case 22 of the magnetic sensor 20. The dimensions of the magnetic sensor 20 may be defined corresponding to one of a transistor outline (TO) package dimension selected from a group consisting of TO-3, TO-5, TO-8, TO-18, TO-39, TO-46, TO-52, and TO-72.

Accordingly, a fuel level sensor assembly 42, magnetic sensor 20 for the fuel level sensor assembly 42, and a fuel tank assembly 60 is provided. The magnetic sensor 20 may significantly reduce the size (approximately 5 mm by 5 mm in the TO-18 package) of the sensing element inside the fuel tank and allow voltage supply and output signal conditioning circuitry to be located outside the vehicle fuel tank 62 where it is in a less aggressive environment. Typically, magnetic sensing elements are over-molded with plastic since plastic is typically inexpensive, non-magnetic, and it may provide a thin layer over the magnetic sensing element to decrease the distance to the magnet or ferrous target. Even though a plastic encapsulated magnetic sensing element may typically have a lower cost than the magnetic sensor 20, the plastic encapsulated magnetic sensing element would require secondary operations and materials to isolate the magnetic sensing element from the fuel. This may create additional failure modes, complexity, risk, and cost for the plastic encapsulated magnetic sensing element compared to the magnetic sensor 20. Additionally, packaging the magnetic sensing element in a standard transistor outline (TO) package allows the use of existing, proven, and high volume assembly processes.

While this invention has been described in terms of the preferred embodiments thereof, it is not intended to be so limited, but rather only to the extent set forth in the claims that follow. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

We claim:

1. A fuel level sensor assembly configured to be installed in a vehicle fuel tank, said assembly comprising:
a case that defines a cavity and an opening, wherein the case is formed of non-magnetic metal;
a cap defining a via, said cap fixedly attached to the opening;
a magnetic sensing element located within the cavity, said magnetic sensing element defining a contact area for making electrical contact to the magnetic sensing element,
a pin protruding through the via;
a wire bonded to the contact area and the pin, wherein the wire electrically connects the magnetic sensing element to the pin; and
a sealant located within the via between the pin and the cap, whereby the sealant defines a hermetic seal between the pin and the cap, wherein the case, the cap, the magnetic sensing element, the pin, the wire, and the sealant are assembled to form a magnetic sensor.

2. The assembly of claim 1, wherein the assembly further comprises
a base defining a surface for mounting the magnetic sensor;
a float arm having a first end rotatably supported by the base for rotation about an axis offset from the magnetic sensor by a first distance;
a magnet attached to the first end and positioned to rotate about a first axis and offset by a second distance;
a float attached to a second end of the float arm, whereby movement of the float about the first axis causes rotation of the first end; and
an interface circuit electrically connected to the pin, wherein the interface circuit is configured to condition a voltage supply of the magnetic sensing element and converts a magnetic sensing element output to interface with a vehicle controller.

3. The assembly of claim 2, wherein the interface circuit is configured to be located outside of the vehicle fuel tank.

4. The assembly of claim 2, wherein the interface circuit is configured to be located within the vehicle fuel tank.

5. The assembly of claim 4, wherein the interface circuit is configured to be located within the case.

6. The assembly of claim 1, wherein the magnetic sensor defines dimensions corresponding to one of a transistor outline (TO) package dimension selected from a group consisting of TO-3, TO-5, TO-8, TO-18, TO-39, TO-46, TO-52, and TO-72.

7. The assembly of claim 6, wherein the magnetic sensor defines dimensions corresponding to the TO-18 package dimensions.

8. A fuel tank assembly configured to be installed in a vehicle, said assembly comprising:
a fuel tank;
a magnetic sensor including a case that defines a cavity and an opening, wherein the case is formed of non-magnetic metal, a cap defining a via, said cap fixedly attached to the opening, a magnetic sensing element located within the cavity, said magnetic sensing element defining a contact area for making electrical contact to the magnetic sensing element, a pin protruding through the via, a wire bonded to the contact area and the pin, wherein the wire electrically connects the magnetic sensing element to the pin, and a sealant located within the via between the pin and the cap, whereby the sealant defines a hermetic seal between the pin and the cap;
a base defining a surface for mounting the magnetic sensor;
a float arm having a first end rotatably supported by the base for rotation about an axis offset from the magnetic sensor by a first distance;
a magnet attached to the first end and positioned to rotate about a first axis and offset by a second distance;
a float attached to a second end of the float arm, whereby movement of the float about the first axis causes rotation of the first end; and
an interface circuit electrically connected to the pin, wherein the interface circuit is configured to condition a voltage supply of the magnetic sensing element and converts an electrical output of the magnetic sensing element to interface with a vehicle controller.

9. The assembly of claim 8, wherein the interface circuit is configured to be located outside of the fuel tank.

10. The assembly of claim 8, wherein the interface circuit is configured to be located within the fuel tank.

11. The assembly of claim 10, wherein the interface circuit is configured to be located within the case.

12. The assembly of claim 8, wherein the magnetic sensor defines dimensions corresponding to one of a transistor outline (TO) package dimension selected from a group consisting of TO-3, TO-5, TO-8, TO-18, TO-39, TO-46, TO-52, and TO-72.

13. The assembly of claim 12, wherein the magnetic sensor defines dimensions corresponding to the TO-18 package dimensions.
